(19) United States
(12) Patent Application Publication
(10) Pub. No.: US 2026/0252470 A1
(43) Pub. Date: Aug. 27, 2026

(54) SYSTEMS AND METHODS FOR PROVIDING AUTOMATED TEST SCRIPT GENERATION

(71) Applicant: Verizon Patent and Licensing Inc., Basking Ridge, NJ (US)

(72) Inventors: Ramakrishnan MUTHUKRISHNAN, Bridgewater, NJ (US); Jayaprakash NARU, Carrollton, TX (US); Venkata KANITHI, Bridgewater, NJ (US); Karthikeyan KADIRVEL, Chennai (IN); Anil S. KUMAR, Hyderabad (IN); Varalakshmi GANDI, Medchal (IN); Prabanch Valia Perumal ARASU, Chennai (IN); Rebeca VARA VARGAS, Astoria, NY (US); Senthil MUTHUSAMY, Frisco, TX (US)

(73) Assignee: Verizon Patent and Licensing Inc., Basking Ridge, NJ (US)

(21) Appl. No.: 19/059,837

(22) Filed: Feb. 21, 2025

(51) Int. Cl. G06F 11/3668; G06F 8/36

(52) U.S. Cl. CPC G06F 11/3684; G06F 8/36

(57) ABSTRACT

A device may receive, from a test management tool, test case information that includes test steps and expected results, and may retrieve existing automation test scripts and methods from a knowledge base based on the test case information. The device may identify reusable methods and objects from the existing automation test scripts and methods, and may generate, based on the reusable methods and objects, a new automation test script corresponding to the test case information. The device may validate the new automation test script for consistency and reusability with the existing automation test scripts.

### BACKGROUND

In software development, the automation of testing represents a significant advancement in ensuring the robustness of software systems before release.

### BRIEF DESCRIPTION OF THE DRAWINGS

FIGS. 1A-1F are diagrams of an example associated with providing automated test script generation.

FIG. 2 is a diagram of an example environment in which systems and/or methods described herein may be implemented.

FIG. 3 is a diagram of example components of one or more devices of FIG. 2.

FIG. 4 is a flowchart of an example process for providing automated test script generation.

### DETAILED DESCRIPTION OF EXAMPLE EMBODIMENTS

The following detailed description of example implementations refers to the accompanying drawings. The same reference numbers in different drawings may identify the same or similar elements.

Automation testing involves using specialized tools and scripts to automatically execute tests on software to find defects or confirm that features work as intended. However, a major hurdle in making this process more efficient is the manual creation and maintenance of automation test scripts. These scripts are written by automation engineers and are utilized to validate the functionality and performance of software under various conditions. Automation engineers dedicate a substantial amount of effort to write, verify, and maintain these scripts. This process heavily relies on the individual expertise of engineers, which can become a bottleneck, particularly in larger or more dynamic development environments where software changes are frequent. Thus, current techniques for automation testing consume computing resources (e.g., processing resources, memory resources, communication resources, and/or the like), networking resources, and/or other resources associated with failing to perform software testing in a timely manner, reducing the productivity and efficiency of the software development life cycle due to failing to perform software testing in a timely manner, handling customer complaints associated with not receiving software in a timely manner, and/or the like.

Some implementations described herein provide a generation system that provides automated test script generation. For example, the generation system may receive, from a test management tool, test case information that includes test steps and expected results, and may retrieve existing automation test scripts and methods from a knowledge base based on the test case information. The generation system may identify reusable methods and objects from the existing automation test scripts and methods, and may generate, based on the reusable methods and objects, a new automation test script corresponding to the test case information. The generation system may validate the new automation test script for consistency and reusability with the existing automation test scripts, and may cause the validated new automation test script to be implemented by the test management tool.

In this way, the generation system provides automated test script generation. For example, the generation system may optimize the creation and maintenance of automation test scripts. By leveraging an up-to-date knowledge base, the generation system may ensure greater uniformity in test script generation and may maintain high reusability. Furthermore, the automation of test methods and page object models by the generation system may increase the efficiency of test script updates, leading to a more agile and responsive testing procedure that better aligns with continuous integration and development practices. This results in a more effective utilization of testing resources and minimizes the latency between code changes and their verification, effectively reducing a time of a development cycle. Additionally, by automating the adaptation of test scripts to software changes, the generation system may ensure that code quality and test coverage remain high. Thus, the generation system may conserve computing resources, networking resources, and/or other resources that would have otherwise been consumed by failing to perform software testing in a timely manner, reducing the productivity and efficiency of the software development life cycle due to failing to perform software testing in a timely manner, handling customer complaints associated with not receiving software in a timely manner, and/or the like.

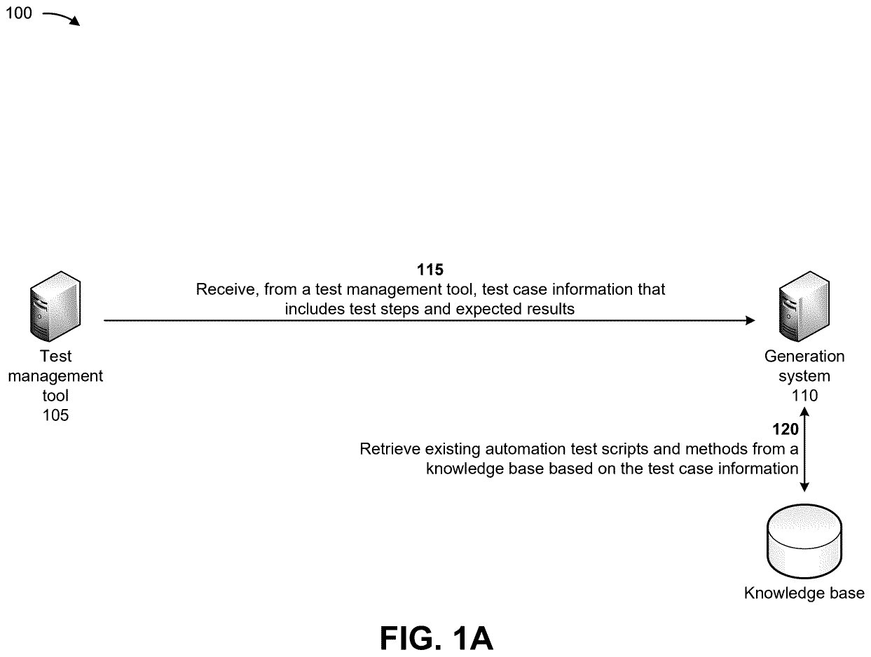

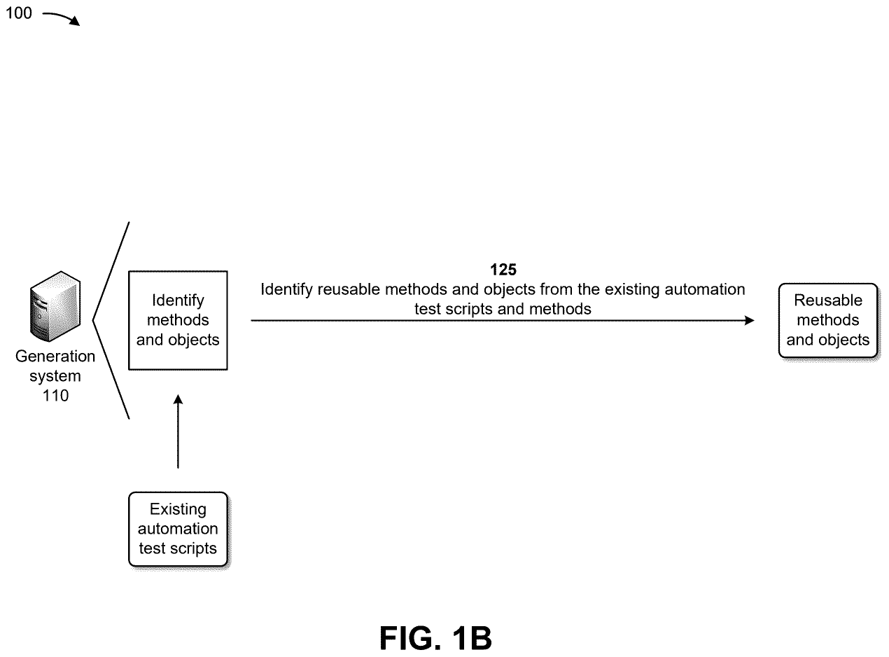

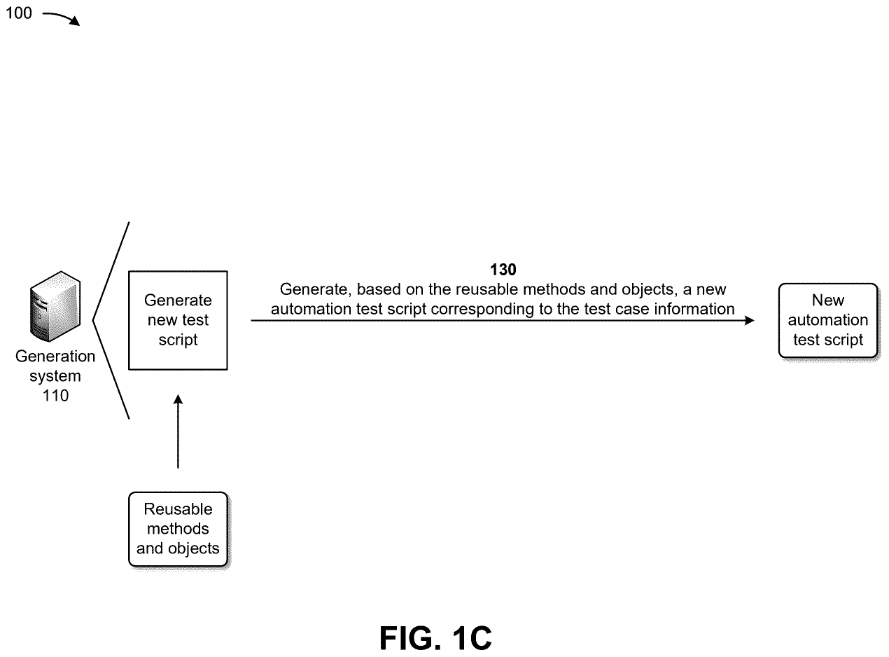

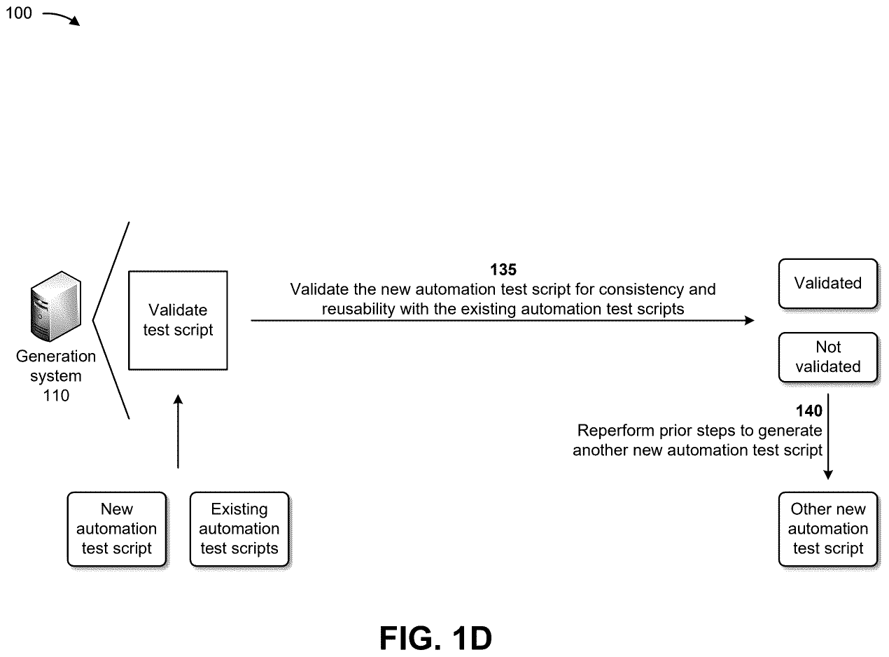

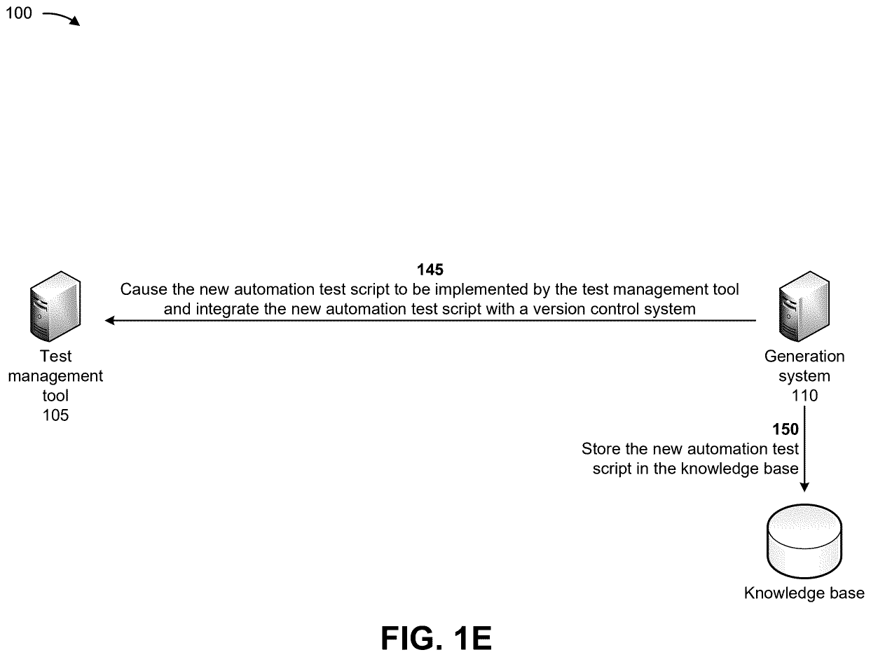

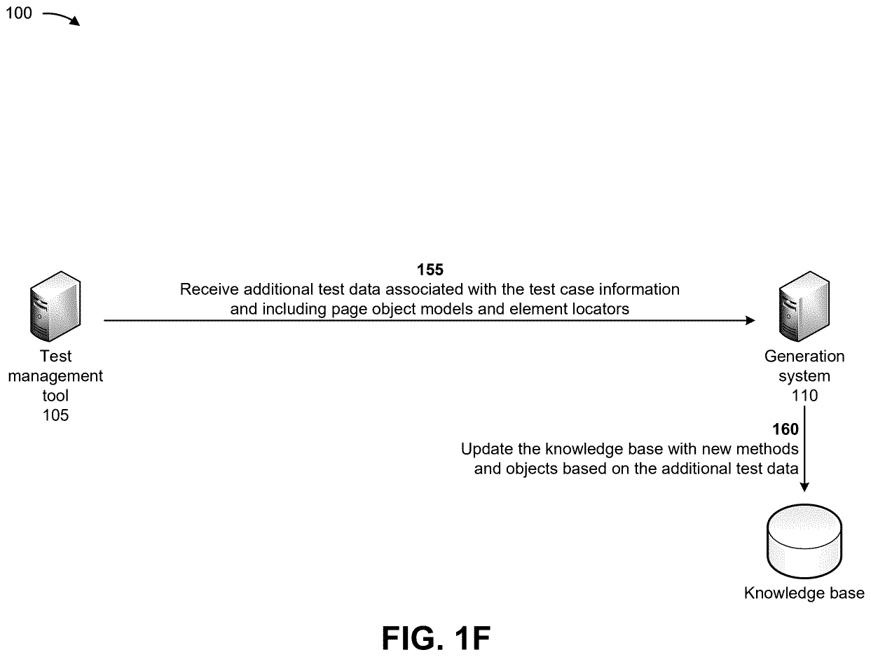

FIGS. 1A-1F are diagrams of an example 100 associated with providing automated test script generation. As shown in FIGS. 1A-1F, the example 100 includes a test management tool 105 and a knowledge base associated with a generation system 110. The test management tool 105 may provide test case information (e.g., Q-test® test cases) to the generation system 110. The knowledge base may include a data structure (e.g., a database, a table, a list, and/or the like) that stores automation test scripts. The generation system 110 may include a system that provides automated test script generation. Further details of the test management tool 105, the knowledge base, and the generation system 110 are provided elsewhere herein. Although implementations described herein depict a single test management tool 105, in some implementations, the generation system 110 may be associated with multiple test management tools 105.

As shown by FIG. 1A, and by reference number 115, the generation system 110 may receive, from the test management tool 105, test case information that includes test steps and expected results. For example, a user may utilize the test management tool 105 to define the test case information, and may cause the test management tool 105 to provide the test case information to the generation system 110. The generation system 110 may receive the test case information from the test management tool 105. The test case information may include details about the steps that need to be tested and the expected outcomes of these steps (e.g., the expected results). In some implementations, the test case information may include combined descriptions of the test steps and the expected results. This combined description can streamline the testing process by providing a comprehensive view of each test case in a single document.

Additionally, or alternatively, test case information may include various details, such as user interactions and system responses for specific scenarios. These details may provide a clear understanding of how users interact with the test management tool 105 and what system behavior is expected from the test management tool 105. Additionally, or alternatively, the test case information may include test cases that specify the procedural steps and the anticipated results needed for automation testing. Test cases may be well-structured and may provide a clear framework for automation. A test case may include a document that outlines specific testing criteria for software applications. A test case may include detailed information about the test steps to be executed, the expected results for each step, and any necessary preconditions or data setups.

In some implementations, the generation system 110 may utilize a combination of natural language processing (NLP) and pattern recognition technologies to analyze and interpret the test case information provided. For example, upon receiving test case information that includes test steps and expected results, an NLP module of the generation system 110 may parse the text to extract actionable tasks, identifying keywords and phrases that correspond to specific automation actions. The NLP module may utilize pre-trained models such as bidirectional encoder representations from transformers (BERT) to improve the comprehension of context within the test steps.

As further shown in FIG. 1A, and by reference number 120, the generation system 110 may retrieve existing automation test scripts and methods from a knowledge base based on the test case information. For example, the knowledge base may store classes, methods, page object models, and element locators used in previously generated automation test scripts. Page object models and element locators may help define the structure and components of a user interface, facilitating the automation process. By referencing the test case information, the generation system 110 may query the knowledge base to retrieve relevant methods and existing automation test scripts that can be reused or adapted for the current testing scenario specified by the test case information. In some implementations, the generation system 110 may access the knowledge base to retrieve existing methods and scripts that have been previously developed and stored. This access may allow the generation system 110 to efficiently find and utilize pre-existing resources (e.g., the existing automation test scripts and methods), reducing the time needed to create new automation test scripts.

To retrieve the relevant methods and the existing automation test scripts and methods, the generation system 110 may retrieve the existing automaton test scripts extracted based on the existing test case information and the existing automation test script pairs in the knowledge base. The generation system 110 may retrieve the relevant methods from the knowledge base (e.g., where an embedding is created with respect to a function name and a document string) by comparing the test steps and the expected results to extract the relevant methods.

Additionally, or alternatively, the knowledge base can provide class definitions, methods, and object locators that are relevant to the existing automation test scripts and methods retrieved by the generation system 110. The class definitions and methods may contribute to the organization and consistency of the automation test scripts. Retrieving the existing automation test scripts and methods from the knowledge base may ensure the reuse of established automation components, enabling consistent and efficient generation of new automation test scripts. In some implementations, the knowledge base may be structured as a relational database with multiple tables storing structured automation test scripts, associated metadata, and reusable components. Each table entry in the knowledge base may include fields, such as unique identifiers for test scripts, method names, parameter definitions, and links to libraries or external resources. An exemplary structured query language (SQL) schema for such a system can include tables like Scripts, Methods, PageObjects, and ElementLocators. The Scripts table may store script identifiers and general script details, while the Methods table may store method-specific information like name, description, and code snippets.

As shown in FIG. 1B, and by reference number 125, the generation system 110 may identify reusable methods and objects from the existing automation test scripts and methods. For example, the generation system 110 may compare the test case information with the existing automation test scripts and methods retrieved from the knowledge base. Based on conducting the comparison, the generation system 110 may determine which existing methods and objects from the existing automation test scripts and methods can be effectively reused for generation of new automation test scripts in accordance with the test case information. The detailed comparison may ensure that no useful components are overlooked during the new automation test script generation process, and may ensure consistency and efficiency in the process. By identifying the reusable methods and objects from the existing automation test scripts and methods, the generation system 110 may enhance the maintainability of the automation test scripts, thereby significantly reducing the time involved in generating new automation test scripts from scratch. This may ensure high reusability of existing automation test scripts and methods and may promote uniformity of automation test scripts across multiple testing scenarios. In some implementations, identifying the reusable methods and objects from the existing automation test scripts and methods may include the generation system 110 analyzing the test steps of the test case information to determine corresponding existing and reusable methods and objects stored in the knowledge base.

As shown in FIG. 1C, and by reference number 130, the generation system 110 may generate, based on the reusable methods and objects, a new automation test script corresponding to the test case information. For example, the generation system 110 may compile the reusable methods and objects identified from the knowledge base to create the new automation test script tailored to the provided test case information. This may ensure that the new automation test script leverages existing tested components, thus reducing the need for writing automation test scripts from scratch and enhancing consistency and reliability across test cases. Moreover, utilizing the reusable methods and objects may facilitate faster new automation test script generation and easier updates when modifications are needed, significantly improving the efficiency of the test automation process.

As shown in FIG. 1D, and by reference number 135, the generation system 110 may validate the new automation test script for consistency and reusability with the existing automation test scripts. For example, the generation system 110 may compare the new automation test script with the existing automation test scripts retrieved from the knowledge base to ensure that the new automation test script adheres to established standards and practices indicated by the existing automation test scripts. The generation system 110 may validate the new automation test script by executing the new automation test script to check for errors or inconsistencies, verifying correct interactions between test steps and automation components, and ensuring that the reusable methods and objects are correctly implemented. In some implementations, the generation system 110 may validate the new automation test script by validating the new automation test script for alignment with industry standards and predefined criteria. For example, the generation system 110 may compare the new automation test script with the existing automation test scripts to ensure compliance with established protocols.

In some implementations, the generation system 110 may generate a validated test script based on the new automation script, the existing automation test scripts, and the reusable automation methods. The generation system 110 may utilize a large language model (LLM), with a prompt instruction requesting whether only existing methods are utilized and no randomly-generated methods are utilized, to validate the new automation test script for consistency and reusability with the existing automation test scripts.

Additionally, the generation system 110 may execute the new automation test script in a controlled environment to detect any errors or inconsistencies and to verify proper interaction between test steps and automation components, confirming that the reusable methods and objects are correctly applied. Additionally, or alternatively, the generation system 110 may utilize the LLM to ensure that all test steps and automation components of the new automation test script interact appropriately and that the reusable methods and objects are correctly utilized. Additionally, or alternatively, the generation system 110 may utilize a machine learning model to validate the new automation test script for consistency and reusability with the existing automation test scripts. For example, the machine learning model may compare the new automation test script with the existing automation test scripts, and may identify any anomalies based on the comparison. The machine learning model may include a convolutional neural network (CNN) model (e.g., a bilingual evaluation understudy (BLEU) model) with at least three hidden layers. This model may be trained using a dataset encompassing previously validated test scripts. The hyperparameters for the model may include a learning rate (e.g., of 0.001), a batch size (e.g., of 32), and epochs of training (e.g., 100 epochs).

In some implementations, when the generation system 110 validates the new automation test script, the generation system 110 may utilize a suite of unit tests that automatically execute the new automation test script in a sandbox environment. This sandbox environment replicates various scenarios outlined in the test case information without impacting live systems. Such unit tests can be implemented using frameworks like JUnit or TestNG for Java-based systems. An example set of validation checks can include a syntax validation (e.g., ensuring the generated script adheres to the syntax rules of the target automation framework), consistency checks (e.g., comparing newly generated methods against previously stored methods to ensure reusability and the absence of redundant code), and performance benchmarks (e.g., executing the script to ensure that it meets pre-defined performance metrics for execution time and resource usage).

As further shown in FIG. 1D, and by reference number 140, the generation system 110 may reperform prior steps to generate another new automation test script when the new automation test script is not validated. For example, if the initial validation process identifies discrepancies or non-compliance with the existing automation test scripts, the generation system 110 may analyze the errors, identify potential solutions, and then reattempt the generation of the new automation test script. This iterative cycle may ensure that the final new automation test script is both consistent with the existing automation framework and reusable across different test scenarios. In some implementations, when the new automation test script is not validated, the generation system 110 may retrieve different existing automation test scripts and methods from the knowledge base based on the test case information, and may identify different reusable methods and objects from the different existing automation test scripts and methods. The generation system 110 may generate, based on the different reusable methods and objects, a different new automation test script corresponding to the test case information.

As shown in FIG. 1E, and by reference number 145, the generation system 110 may cause the new automation test script to be implemented by the test management tool 105 and may integrate the new automation test script with a version control system. For example, when the new automation test script is validated, the generation system 110 may cause the test management tool 105 to implement the new automation test script. In some implementations, the generation system 110 may, upon validation of the new automation test script, cause the test management tool 105 to execute the new automation test script. This execution allows for automated testing to commence, ensuring that the new automation test script performs as expected in real-world scenarios. Additionally, or alternatively, the generation system 110 may synchronize the new automation test script across multiple environments by utilizing the test management tool 105. This synchronization may ensure that the new automation test script can be used consistently across various testing and staging environments, helping to maintain uniformity in testing results. Additionally, or alternatively, the generation system 110 may, after validation, deploy the new automation test script into a continuous integration/continuous deployment (CI/CD) pipeline via the test management tool 105. By deploying the new automation test script into a CI/CD pipeline, continuous testing and deployment are facilitated, promoting rapid development and deployment cycles. Additionally, or alternatively, the generation system 110 may employ the new automation test script within the test management tool 105 to facilitate regression testing processes. The generation system 110 can thereby ensure that new changes do not adversely affect existing functionalities.

In some implementations, when the new automation test script is validated, the generation system 110 may also integrate the new automation test script with a version control system. A version control system is a software tool that helps manage and track changes to code and other digital files over time. It allows multiple developers to collaborate on a project by providing mechanisms to record modifications, revert to previous versions, and resolve conflicts that arise from simultaneous edits. Additionally, or alternatively, the generation system 110 may track updates and changes to the new automation test script using the version control system, allowing rollbacks and merges. This tracking enhances the control over the new automation test script and mitigates the risks associated with changes over time. Additionally, or alternatively, the generation system 110 may integrate the new automation test script into a repository system to manage, version, and track the new automation test script. The repository system may provide a structured environment where the new automation test script can be maintained and accessed efficiently.

To integrate new automation test scripts with version control, the generation system 110 may utilize tools like Git. Upon validation, the validated new automation test script may be committed to a repository, and tagged with version identifiers and metadata for tracking purposes. Automated scripts within continuous integration pipelines, such as Jenkins, may monitor these repositories to trigger further testing or deployment activities whenever changes are detected.

As further shown in FIG. 1E, and by reference number 150, the generation system 110 may store the new automation test script in the knowledge base. For example, when the new automation test script is validated, the generation system 110 may store the new automation test script in the knowledge base. The addition of the new automation test script to the knowledge base helps to build a richer library of automation test scripts that can be reused and referenced for future testing needs. Additionally, or alternatively, the generation system 110 may index the new automation test script in the knowledge base, making it easily retrievable for subsequent test script generation tasks. This indexing may enhance the searchability and accessibility of the new automation test script within the knowledge base.

As shown in FIG. 1F, and by reference number 155, the generation system 110 may receive additional test data associated with the test case information and including page object models and element locators. For example, the generation system 110 may receive the additional test data from the test management tool 105. The additional test data may be associated with the test case information and may include page object models and element locators. The additional test data may include information about user interface elements and their interaction patterns, which may be pertinent to the test case information previously received from the test management tool 105. The additional test data may include identifiers for various page objects, their attributes, and locator strategies that help in identifying user interface elements during automated testing. In some implementations, the generation system 110 may process the page object models and the element locators, and may identify relevant user interface elements and their attributes for inclusion in the test case information based on processing the page object models and the element locators. Additionally, or alternatively, the generation system 110 may utilize the additional test data to add new and updated information to the knowledge base with new and updated information. This enrichment of the knowledge base may ensure that the latest details about user interface elements are accounted for in future automation test script generation. In some implementations, the generation system 110 may store the additional test data in a separate data structure (e.g., another knowledge base).

As further shown in FIG. 1F, and by reference number 160, the generation system 110 may update the knowledge base with new methods and objects based on the additional test data. For example, the generation system 110 may incorporate the new page object models and the element locators into the knowledge base to ensure that the latest user interface elements are available for future automation test script generation. This continuous update may ensure that the generation system 110 is equipped with the latest methods and interaction patterns needed for generating up-to-date and relevant automation test scripts.

In some implementations, the generation system 110 may be utilized with a page object method. In such implementations, the test data may include filter conditions required to obtain customer information. The customer information may be retrieved based on similar automation scripts stored in a vector database. The test data may also include data indicating what device needs to be selected for an ordering flow (e.g., which is provided in the test case). For the page object method, the generation system 110 may utilize a page and an elements locator (e.g., a knowledge base) to generate the test script. The generation system 110 may extract associated test steps and expected results from a test instruction. For each test step, the generation system 110 may retrieve all the elements and a locator from the vector database, and may validate the elements and the locator if the generation system 110 is not extracting a new set of elements. The generation system 110 may then generate object-action pairs. For each object-action pair, the generation system 110 may check in vector database for reusable page methods and reusable components. The generation system 110 may generate the test script for the each of the pages and may utilize merger to update the test script.

In this way, the generation system 110 provides automated test script generation. For example, the generation system 110 may optimize the creation and maintenance of automation test scripts. By leveraging an up-to-date knowledge base, the generation system 110 may ensure greater uniformity in test script generation and may maintain high reusability. Furthermore, the automation of test methods and page object models by the generation system 110 may increase the efficiency of test script updates, leading to a more agile and responsive testing procedure that better aligns with continuous integration and development practices. This results in a more effective utilization of testing resources and minimizes the latency between code changes and their verification, effectively reducing a time of a development cycle. Additionally, by automating the adaptation of test scripts to software changes, the generation system 110 may ensure that code quality and test coverage remain high. Thus, the generation system 110 may conserve computing resources, networking resources, and/or other resources that would have otherwise been consumed by failing to perform software testing in a timely manner, reducing the productivity and efficiency of the software development life cycle due to failing to perform software testing in a timely manner, handling customer complaints associated with not receiving software in a timely manner, and/or the like.

As indicated above, FIGS. 1A-1F are provided as an example. Other examples may differ from what is described with regard to FIGS. 1A-1F. The number and arrangement of devices shown in FIGS. 1A-1F are provided as an example. In practice, there may be additional devices, fewer devices, different devices, or differently arranged devices than those shown in FIGS. 1A-1F. Furthermore, two or more devices shown in FIGS. 1A-1F may be implemented within a single device, or a single device shown in FIGS. 1A-1F may be implemented as multiple, distributed devices. Additionally, or alternatively, a set of devices (e.g., one or more devices) shown in FIGS. 1A-1F may perform one or more functions described as being performed by another set of devices shown in FIGS. 1A-1F.

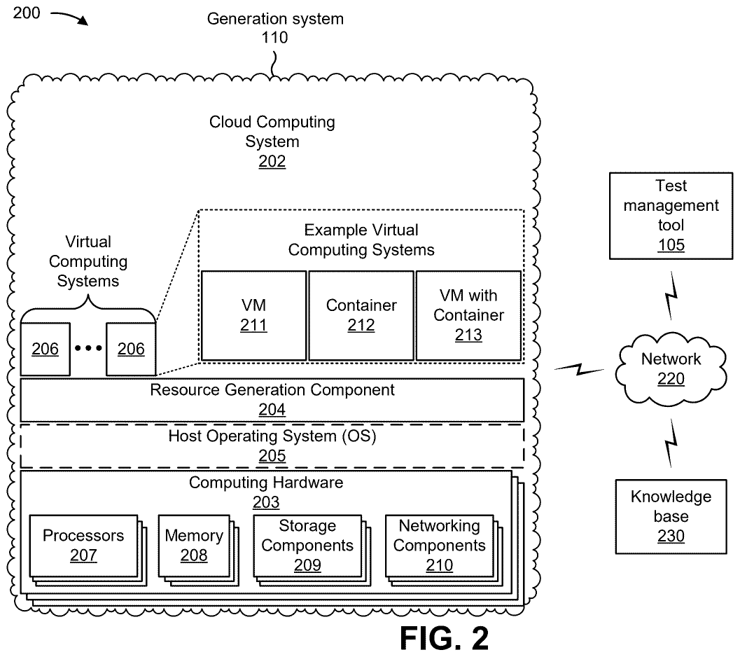

FIG. 2 is a diagram of an example environment 200 in which systems and/or methods described herein may be implemented. As shown in FIG. 2, the environment 200 may include the generation system 110, which may include one or more elements of and/or may execute within a cloud computing system 202. The cloud computing system 202 may include one or more elements 203-213, as described in more detail below. As further shown in FIG. 2, the environment 200 may include the test management tool 105, a network 220, and/or a knowledge base 230. Devices and/or elements of the environment 200 may interconnect via wired connections and/or wireless connections.

The test management tool 105 may include one or more devices capable of receiving, generating, storing, processing, providing, and/or routing information, as described elsewhere herein. The test management tool 105 may include a communication device and/or a computing device. For example, the test management tool 105 may include a server, such as an application server, a client server, a web server, a database server, a host server, a proxy server, a virtual server (e.g., executing on computing hardware), or a server in a cloud computing system. In some implementations, the test management tool 105 may include computing hardware used in a cloud computing environment, such as one or more serverless components (e.g., one or more serverless functions).

The cloud computing system 202 includes computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 includes hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, one or more storage components 209, and/or one or more networking components 210. Examples of a processor, a memory, a storage component, and a networking component (e.g., a communication component) are described elsewhere herein.

The resource management component 204 includes a virtualization application (e.g., executing on hardware, such as the computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 211. Additionally, or alternatively, the resource management component 204 may include a container manager, such as when the virtual computing systems 206 are containers 212. In some implementations, the resource management component 204 executes within and/or in coordination with a host operating system 205.

A virtual computing system 206 includes a virtual environment that enables cloud-based execution of operations and/or processes described herein using the computing hardware 203. As shown, the virtual computing system 206 may include a virtual machine 211, a container 212, or a hybrid environment 213 that includes a virtual machine and a container, among other examples. The virtual computing system 206 may execute one or more applications using a file system that includes binary files, software libraries, and/or other resources required to execute applications on a guest operating system (e.g., within the virtual computing system 206) or the host operating system 205.

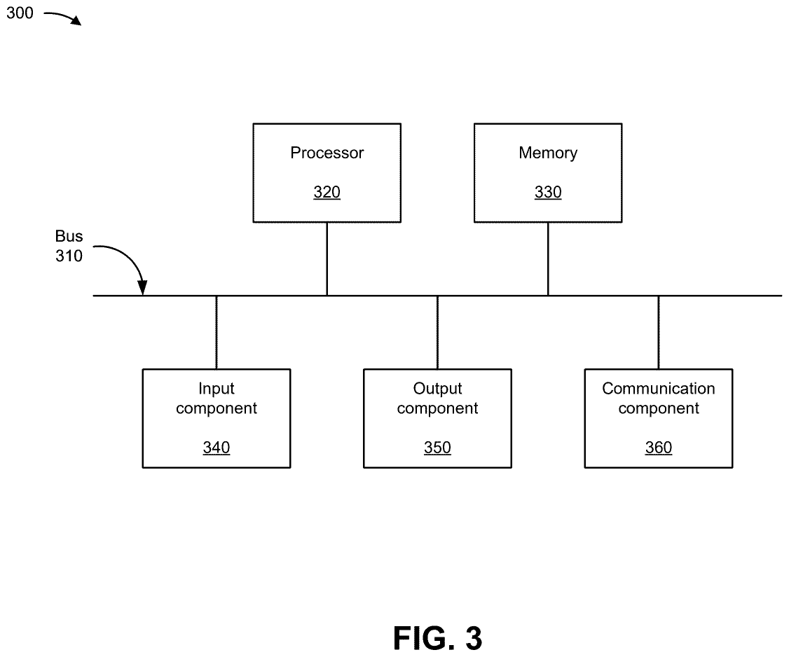

Although the generation system 110 may include one or more elements 203-213 of the cloud computing system 202, may execute within the cloud computing system 202, and/or may be hosted within the cloud computing system 202, in some implementations, the generation system 110 may not be cloud-based (e.g., may be implemented outside of a cloud computing system) or may be partially cloud-based. For example, the generation system 110 may include one or more devices that are not part of the cloud computing system 202, such as a device 300 of FIG. 3, which may include a standalone server or another type of computing device. The generation system 110 may perform one or more operations and/or processes described in more detail elsewhere herein.

The network 220 includes one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The knowledge base 230 may include one or more devices capable of receiving, generating, storing, processing, and/or providing information, as described elsewhere herein. The knowledge base 230 may include a communication device and/or a computing device. For example, the knowledge base 230 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The knowledge base 230 may communicate with one or more other devices of the environment 200, as described elsewhere herein.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300, which may correspond to the test management tool 105, the generation system 110, and/or the knowledge base 230. In some implementations, the test management tool 105, the generation system 110, and/or the knowledge base 230 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

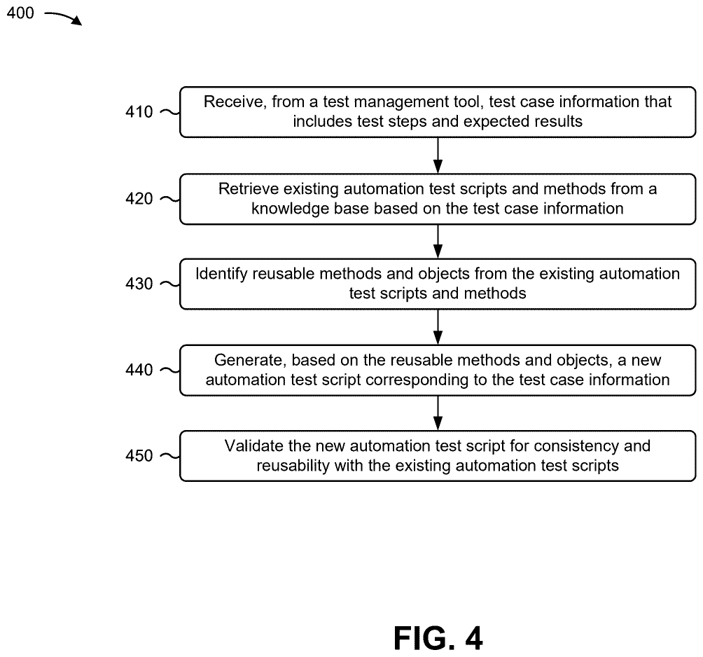

FIG. 4 depicts a flowchart of an example process 400 for providing automated test script generation. In some implementations, one or more process blocks of FIG. 4 may be performed by a device (e.g., the generation system 110). In some implementations, one or more process blocks of FIG. 4 may be performed by another device or a group of devices separate from or including the device, such as a test management tool (e.g., the test management tool 105). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving, from a test management tool, test case information that includes test steps and expected results (block 410). For example, the device may receive, from a test management tool, test case information that includes test steps and expected results, as described above. In some implementations, receiving the test case information includes receiving a test case specifying the test case information. In some implementations, the test case information includes a combined description of the test steps and the expected results.

As further shown in FIG. 4, process 400 may include retrieving existing automation test scripts and methods from a knowledge base based on the test case information (block 420). For example, the device may retrieve existing automation test scripts and methods from a knowledge base based on the test case information, as described above. In some implementations, the knowledge base stores classes, methods, and element locators used in previously generated automation test scripts.

As further shown in FIG. 4, process 400 may include identifying reusable methods and objects from the existing automation test scripts and methods (block 430). For example, the device may identify reusable methods and objects from the existing automation test scripts and methods, as described above. In some implementations, identifying the reusable methods and objects includes analyzing the test steps of the test case information to determine corresponding existing methods and objects stored in the knowledge base.

As further shown in FIG. 4, process 400 may include generating, based on the reusable methods and objects, a new automation test script corresponding to the test case information (block 440). For example, the device may generate, based on the reusable methods and objects, a new automation test script corresponding to the test case information, as described above. In some implementations, generating the new automation test script includes generating test methods and page object models for the new automation test script based on the reusable methods and objects.

As further shown in FIG. 4, process 400 may include validating the new automation test script for consistency and reusability with the existing automation test scripts (block 450). For example, the device may validate the new automation test script for consistency and reusability with the existing automation test scripts, as described above. In some implementations, validating the new automation test script includes executing the new automation test script to verify an accuracy of new test steps generated for the new automation test script. In some implementations, validating the new automation test script includes comparing new test steps, generated for the new automation test script, with the reusable methods and objects to determine consistency.

In some implementations, process 400 includes causing the new automation test script to be implemented by the test management tool. In some implementations, process 400 includes receiving additional test data associated with the test case information, wherein the additional test data includes page object models and element locators. In some implementations, process 400 includes updating the knowledge base with new methods and objects based on the additional test data. In some implementations, process 400 includes standardizing the test case information to ensure compatibility with the knowledge base. In some implementations, process 400 includes integrating the new automation test script with a version control system for maintaining test scripts.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

As used herein, “selectively” performing an operation means to either perform the operation or refrain from performing the operation. For example, selectively performing an operation based on whether a condition is satisfied means that the operation is performed if the condition is satisfied and that the operation is not performed if the condition is not satisfied (or vice versa). Thus, selectively performing an operation may include determining whether to perform the operation and then either performing the operation or refraining from performing the operation based on that determination.

As used herein, “selectively” performing a first operation or a second operation means to perform either the first operation or the second operation. For example, selectively performing a first operation or a second operation based on whether a condition is satisfied means that the first operation is performed if the condition is satisfied and that the second operation is performed if the condition is not satisfied (or vice versa). Thus, selectively performing a first operation or a second operation may include determining whether to perform either the first operation or the second operation and then performing either the first operation or the second operation based on that determination.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device and from a test management tool, test case information that includes test steps and expected results;
retrieving, by the device, existing automation test scripts and methods from a knowledge base based on the test case information;
identifying, by the device, reusable methods and objects from the existing automation test scripts and methods;
generating, by the device and based on the reusable methods and objects, a new automation test script corresponding to the test case information; and
validating, by the device, the new automation test script for consistency and reusability with the existing automation test scripts.

2. The method of claim 1, further comprising:
causing the new automation test script to be implemented by the test management tool.

3. The method of claim 1, wherein receiving the test case information comprises:
receiving a test case specifying the test case information.

4. The method of claim 1, wherein the test case information includes a combined description of the test steps and the expected results.

5. The method of claim 1, wherein identifying the reusable methods and objects comprises:
analyzing the test steps of the test case information to determine corresponding existing methods and objects stored in the knowledge base.

6. The method of claim 1, further comprising:
receiving additional test data associated with the test case information,
wherein the additional test data includes page object models and element locators.

7. The method of claim 6, further comprising:
updating the knowledge base with new methods and objects based on the additional test data.

8. A device, comprising:
one or more processors configured to:
receive, from a test management tool, test case information that includes test steps and expected results;
retrieve existing automation test scripts and methods from a knowledge base based on the test case information;
identify reusable methods and objects from the existing automation test scripts and methods;
generate, based on the reusable methods and objects, a new automation test script corresponding to the test case information;
validate the new automation test script for consistency and reusability with the existing automation test scripts; and
cause the new automation test script to be implemented by the test management tool.

9. The device of claim 8, wherein the knowledge base stores classes, methods, and element locators used in previously generated automation test scripts.

10. The device of claim 8, wherein the one or more processors, to validate the new automation test script, are configured to:
execute the new automation test script to verify an accuracy of new test steps generated for the new automation test script.

11. The device of claim 8, wherein the one or more processors, to validate the new automation test script, are configured to:
compare new test steps, generated for the new automation test script, with the reusable methods and objects to determine consistency.

12. The device of claim 8, wherein the one or more processors are further configured to:
standardize the test case information to ensure compatibility with the knowledge base.

13. The device of claim 8, wherein the one or more processors, to generate the new automation test script, are configured to:
generate test methods and page object models for the new automation test script based on the reusable methods and objects.

14. The device of claim 8, wherein the one or more processors are further configured to:
integrate the new automation test script with a version control system for maintaining test scripts.

15. A non-transitory computer-readable medium storing a set of instructions, the set of instructions comprising:
one or more instructions that, when executed by one or more processors of a device, cause the device to:
receive, from a test management tool, test case information that includes test steps and expected results;
retrieve existing automation test scripts and methods from a knowledge base based on the test case information;
identify reusable methods and objects from the existing automation test scripts and methods;
generate, based on the reusable methods and objects, a new automation test script corresponding to the test case information;
validate the new automation test script for consistency and reusability with the existing automation test scripts; and
integrate the new automation test script with a version control system for maintaining test scripts. [0004]

16. The non-transitory computer-readable medium of claim 15, wherein the one or more instructions further cause the device to:
cause the new automation test script to be implemented by the test management tool.

17. The non-transitory computer-readable medium of claim 15, wherein the one or more instructions, that cause the device to receive the test case information, cause the device to:
receive a test case specifying the test case information.

18. The non-transitory computer-readable medium of claim 15, wherein the one or more instructions, that cause the device to identify the reusable methods and objects, cause the device to:
analyze the test steps of the test case information to determine corresponding existing methods and objects stored in the knowledge base.

19. The non-transitory computer-readable medium of claim 15, wherein the one or more instructions, that cause the device to validate the new automation test script, cause the device to:
execute the new automation test script to verify an accuracy of new test steps generated for the new automation test script.

20. The non-transitory computer-readable medium of claim 15, wherein the one or more instructions, that cause the device to validate the new automation test script, cause the device to:
compare new test steps, generated for the new automation test script, with the reusable methods and objects to determine consistency.
